(19) United States
(12) Patent Application Publication
(10) Pub. No.: US 2006/0063011 A1
(43) Pub. Date: Mar. 23, 2006

(54) Formable water-dispersing plastic bodies and method for the production thereof

(75) Inventors: Thomas Hasskerl, Kronberg (DE); Patrick Becker, Muehtal (DE); Rolf Neeb, Pfungstadt (DE); Ghirmay Seyoum, Egelsbach (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GMBH & CO. KG, DARMSTADT (DE)

(21) Appl. No.: 10/539,057

(22) PCT Filed: Oct. 18, 2003
(86) PCT No.: PCT/EP03/11544

§ 371 Date: Jun. 15, 2005

(30) Foreign Application Priority Data
Dec. 17, 2002 (DE) 102 59 240.3

(51) Int. Cl. B32B 27/06; B05D 1/38; B32B 9/04

(52) U.S. Cl. 428/447; 427/407.1; 427/419.8; 427/387

(57) ABSTRACT

The invention relates to water-dispersing plastic bodies made of a plastic substrate, at least one water-dispersing, inorganic coating (a) and an adhesive promoting intermediate layer (b) arranged between the plastic substrate and the inorganic coating. Said coating can be obtained in such a manner that the intermediate layer applied is (b) made of a mixture with a compound which has an evaporating number smaller than or equal to 20. The sum of the layer thicknesses of the inorganic coating (a) and the intermediate layer (b) is 07 μm at the most.

The present invention relates to thermoformable plastics articles which inhibit water droplet formation and which comprise a plastics substrate, an inorganic coating which inhibits water droplet formation, and an adhesion-promoting intermediate layer located between the plastics substrate and the inorganic coating.

Water present on the surface of plastics which inhibit water droplet formation does not coalesce to give separate droplets: instead, the droplets spread and, on contact, flow together to give a coherent layer. The result is improved light reflection at the water-moistened surface and—in the case of transparent plastics—better transmittance, and less likelihood that water droplets will fall from the underside of the plastics article.

Numerous attempts have been made to produce antifogging coatings composed of crosslinked hydrophilic polymers on water-repellent plastics surfaces.

According to DE-A 21 61 645, a coating of this type is produced from a copolymer composed of alkyl esters, hydroxyalkyl esters, and quaternary aminoalkyl esters of acrylic or methacrylic acid, and methylol ethers of methacrylamide, as crosslinking agent. They initially absorb water, with swelling, whereupon they gradually convert into a form which inhibits water droplet formation. However, the swelling makes the coating soft and perceptible to mechanical damage.

EP-A-0 149 182 also discloses articles which inhibit water droplet formation. These plastics articles comprise an inorganic coating based on SiO₂.

However, a disadvantage of the plastics articles which inhibit water droplet formation and are disclosed in EP-A-0 149 182 is that this type of plastics article completely loses its property of inhibiting water droplet formation when it is thermoformed, while the coating on the formed article takes on a milky haze and becomes unsightly.

However, subsequent forming of the sheets provided with a layer which inhibits water droplet formation is desirable for a wide variety of reasons. In particular, for example, better stackability of flat sheets makes their transport costs lower than those for formed articles.

Another point to be considered is that different companies undertake the production of coated sheets and their use, for example as a structural component. Coated formable structural components can therefore be manufactured for a much wider range of purchasers, when compared with preformed sheets specifically produced for one customer.

Furthermore, many particularly advantageous coating processes cannot be implemented, or are difficult to implement, on formed parts, examples being processes involving rolls or rollers.

In the light of the prior art here stated and discussed, one object of the present invention was to provide plastics articles which inhibit water droplet formation, and which can be thermoformed, without resultant adverse effect on the property of inhibiting water droplet formation, and without the occurrence of haze.

A further object of the present invention was to provide plastics articles which inhibit water droplet formation, and whose coating which inhibits water droplet formation has particularly high adhesion to the plastics substrates. This property should not be impaired by moisture.

Another object of the invention was that the plastics articles have high durability, in particular high resistance to UV radiation or weathering.

Another object on which the invention was based was to provide plastics articles which inhibit water droplet formation and which are particularly easy to produce. For example, substrates which can be used to produce the plastics articles are intended in particular to be those obtainable by extrusion, injection moulding, or else by casting processes.

Another object of the present invention consisted in providing plastics articles which inhibit water droplet formation and which have excellent mechanical properties. This property is particularly important for applications in which the plastics article is intended to have high resistance to impact.

In addition, the plastics articles should have particularly good optical properties.

Another object of the present invention consisted in providing plastics articles whose size and shape can easily be adapted to the requirements.

The plastic articles described in Claim 1 achieve these objects, and also achieve other objects which, although they are not specifically mentioned, are obvious or necessary consequences of the circumstances discussed herein. Useful modifications of the plastics articles of the invention are protected by the subclaims dependent on Claim 1.

Claim 20 achieves the underlying object in relation to a production process.

Plastics articles which inhibit water droplet formation and which can be thermoformed, without resultant adverse effect on the property of inhibiting water droplet formation, and without the occurrence of haze, can be provided by the fact that the adhesion-promoting intermediate layer (b) located between a plastics substrate and an inorganic coating (a) which inhibits water droplet formation is applied from a solution with a solvent which has a volatility index smaller than or equal to 20, the total of the layer thicknesses of the inorganic coating (a) and of the intermediate layer (b) being at most 700 nm.

The particular advantages achieved by the inventive measures are, inter alia, the following:
The coatings which inhibit water droplet formation on the plastics articles of the invention have particularly good adhesion to the plastics substrates, this property not being impaired even on exposure to moisture.
The plastics articles of the invention have high resistance to UV radiation.
The plastics articles of the invention can be produced at low cost.
The plastics articles of the present invention can be adapted to particular requirements. In particular, the size and the shape of the plastics article can be varied widely, with no resultant impairment of formability. Furthermore, the present invention also provides plastics articles with excellent optical properties.
The plastics articles of the present invention have good mechanical properties.

The plastics articles of the invention are obtainable by coating plastics substrates. Plastics substrates suitable for the purposes of the present invention are known per se. These substrates encompass in particular polycarbonates, polystyrenes, polyesters, such as polyethylene terephthalate (PET), which may also have been glycol-modified, and polybutylene terephthalate (PBT), cycloolefinic polymers (COCs) and/or poly(meth)acrylates. Preference is given here to polycarbonates, cycloolefinic polymers and poly-(meth)acrylates, particular preference being given to poly(meth)acrylates.

Polycarbonates are known to persons skilled in the art. Polycarbonates may be formally regarded as polyesters composed of carbonic acid and of aliphatic or aromatic dihydroxy compounds. They are easily obtainable by reacting diglycols or bisphenols with phosgene or carbonic diesters in polycondensation or transesterification reactions.

Preference is given here to polycarbonates which derive from bisphenols. Particular bisphenols among these are 2,2-bis(4-hydroxyphenyl)propane (bisphenol A), 2,2-bis(4-hydroxyphenyl)butane (bisphenol B), 1,1-bis(4-hydroxyphenyl)cyclohexane (bisphenol C), 2,2′-methylenediphenol (bisphenol F), 2,2-bis (3,5-dibromo-4-hydroxyphenyl)propane (tetrabromobisphenol A) and 2,2-bis(3,5-dimethyl-4-hydroxyphenyl)propane (tetramethyl-bisphenol A).

These aromatic polycarbonates are usually prepared by interfacial polycondensation or by transesterification, details being given in Encycl. Polym. Sci. Engng. 11, 648-718.

In interfacial polycondensation, the bisphenols in the form of aqueous alkaline solution are emulsified in inert organic solvents, such as methylene chloride, chlorobenzene or tetrahydrofuran, and reacted with phosgene in a reaction involving stages. Amines are used as catalysts, and phase-transfer catalysts are used in the case of sterically hindered bisphenols. The resultant polymers are soluble in the organic solvents used.

The properties of the polymers may be varied widely via the selection of the bisphenols. If different bisphenols are used together, block polymers can also be constructed in multistage polycondensations.

Cycloolefinic polymes are polymers obtainable by using cyclic olefins, in particular by using polycyclic olefins.

Cyclic olefins encompass, for example, monocyclic olefins, such as cyclopentene, cyclopentadiene, cyclohexene, cycloheptene, cyclooctene, and also alkyl derivatives of these monocyclic olefins having from 1 to 3 carbon atoms, examples being methyl, ethyl or propyl, e.g. methylcyclohexene or dimethylcyclohexene, and also acrylate and/or methacrylate derivatives of these monocyclic compounds. Furthermore, cycloalkanes having olefinic side chains may also be used as cyclic olefins, an example being cyclopentyl methacrylate.

Preference is given to bridged polycyclic olefin compounds. These polycyclic olefin compounds may have the double bond either in the ring, in which case they are bridged polycyclic cycloalkenes, or else in side chains. In that case they are vinyl derivatives, allyloxycarboxy derivatives or (meth)acryloxy derivatives of polycyclic cycloalkane compounds. These compounds may also have alkyl, aryl or aralkyl substituents.

Without any intended resultant restriction, examples of polycyclic compounds are bicyclo[2.2.1]hept-2-ene (norbornene), bicyclo[2.2.1]hept-2,5-diene (2,5-norbornadiene), ethylbicyclo[2.2.1]hept-2-ene (ethylnorbornene), ethylidenebicyclo[2.2.1]hept-2-ene (ethylidene-2-norbornene), phenylbicyclo[2.2.1]hept-2-ene, bicyclo[4.3.0]nona-3,8-diene, tricyclo[4.3.0.1^{2,5}]-3-decene, tricyclo[4.3.0.1^{2,5}]-3,8-decene-(3,8-dihydro-dicyclopentadiene), tricyclo[4.4.0.1^{2,5}]-3-undecene, tetracyclo[4.4.0.1^{2,5},1^{7,10}]-3-dodecene, ethylidenetetracyclo[4.4.0.1^{2,5}.1^{7,10}]-3-dodecene, methyloxycarbonyl-tetracyclo[4.4.0.1^{2,5},1^{7,10}]-3-dodecene, ethylidene-9-ethyltetracyclo[4.4.0.1^{2,5},1^{7,10}]-3-dodecene, pentacyclo[4.7.0.1^{2,5},O,O^{3,13},1^{9,12}]-3-pentadecene, pentacyclo[6.1.1^{3,6}.0^{2,7}.0^{9,13}]-4-pentadecene, hexacyclo[6.6.1.1^{3,6}.1^{10,13}.0^{2,7}.0^{9,14}]-4-heptadecene, dimethylhexacyclo[6.6.1.1^{3,6},1^{10,13}.0^{2,7}.0^{9,14}]-4-heptadecene, bis(allyloxycarboxy)tricyclo[4.3.0.1^{2,5}]decane, bis(methacryloxy)tricyclo[4.3.0.1^{2,5}]decane, bis(acryloxy)tricyclo[4.3.0.1^{2,5}]decane.

The cycloolefinic polymers are prepared using at least one of cycloolefinic compounds described above, in particular the polycyclic hydrocarbon compounds.

The preparation of the cycloolefinic polymers may, furthermore, use other olefins which can be copolymerized with the abovementioned cycloolefinic monomers. Examples of these are ethylene, propylene, isoprene, butadiene, methylpentene, styrene, and vinyltoluene.

Most of the abovementioned olefins, and in particular the cycloolefins and polycycloolefins, may be obtained commercially. Many cyclic and polycyclic olefins are moreover obtainable by Diels-Alder addition reactions. The cycloolefinic polymers may be prepared in a known manner, as set out inter alia in the Japanese Patent Specifications 11818/1972, 43412/1983, 1442/1986 and 19761/1987 and in the published Japanese Patent Applications Nos. 75700/1975, 129434/1980, 127728/1983, 168708/1985, 271308/1986, 221118/1988 and 180976/1990 and in the European Patent Applications EP-A-0 6 610 851, EP-A-0 6 485 893, EP-A-0 6 407 870 and EP-A-0 6 668 801.

The cycloolefinic polymers may, for example, be polymerized in a solvent, using aluminium compounds, vanadium compounds, tungsten compounds or boron compounds as catalyst.

It is assumed that, depending on the conditions, in particular on the catalyst used, the polymerization can proceed with ring-opening or with opening of the double bond.

It is also possible to obtain cycloolefinic polymers by free-radical polymerization, using light or an initiator as free-radical generator. This applies in particular to the acryloyl derivatives of the cycloolefins and/or cycloalkanes. This type of polymerization may take place either in solution or else in bulk.

Another preferred plastics substrate encompasses poly(meth)acrylates. These polymers are generally obtained by free-radical polymerization of mixtures which comprise (meth)acrylates. The term (meth)acrylates encompasses methacrylates and acrylates, and also mixtures of the two.

These monomers are well known. Among them are, inter alia, (meth)acrylates derived from saturated alcohols, e.g. methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate; (meth)acrylates derived from unsaturated alcohols, e.g. oleyl (meth)acrylate, 2-propynyl (meth)acrylate, allyl (meth)acrylate, vinyl (meth)acrylate; aryl (meth)acrylates, such as benzyl (meth)acrylate or phenyl (meth)acrylate, where each of the aryl radicals may be unsubstituted or have up to four substituents;
cycloalkyl (meth)acrylates, such as 3-vinylcyclohexyl (meth)acrylate, bornyl (meth)acrylate;
hydroxyalkyl (meth)acrylates, such as
3-hydroxypropyl (meth)acrylate,
3,4-dihydroxybutyl (meth)acrylate,
2-hydroxyethyl (meth)acrylate, 2-hydroxypropyl (meth)acrylate;
glycol di(meth)acrylates, such as 1,4-butanediol di(meth)acrylate,
(meth)acrylates of ether alcohols, such as
tetrahydrofurfuryl (meth)acrylate, vinyloxyethoxyethyl (meth)acrylate;
amides and nitriles of (meth)acrylic acid, e.g.
N-(3-dimethylaminopropyl)(meth)acrylamide,
N-(diethylphosphono)(meth)acrylamide,
1-methacryloylamido-2-methyl-2-propanol;
sulphur-containing methacrylates, such as ethylsulphinylethyl (meth)acrylate,
4-thiocyanatobutyl (meth)acrylate,
ethylsulphonylethyl (meth)acrylate,
thiocyanatomethyl (meth)acrylate,
methylsulphinylmethyl (meth)acrylate,
bis((meth)acryloyloxyethyl) sulphide;
multifunctional (meth)acrylates, such as
trimethyloylpropane tri(meth)acrylate,
pentaerythritol tetra(meth)acrylate and
pentaerythritol tri(meth)acrylate.

In one preferred aspect of the present invention, these mixtures comprise at least 40% by weight, preferably at least 60% by weight, and particularly preferably at least 80% by weight, of methyl methacrylate, based on the weight of monomers.

Besides the (meth)acrylates set out above, the compositions to be polymerized may also comprise other unsaturated monomers which are copolymerizable with methyl methacrylate and with the abovementioned (meth)acrylates.

Examples of these are 1-alkenes, such as 1-hexene, 1-heptene; branched alkenes, such as vinylcyclohexane, 3,3-dimethyl-1-propene, 3-methyl-1-diisobutylene, 4-methyl-1-pentene;
acrylonitrile; vinyl esters, such as vinyl acetate;
styrene, substituted styrenes having one alkyl substituent in the side chain, e.g. α-methylstyrene and α-ethylstyrene, substituted styrenes having one alkyl substituent on the ring, e.g. vinyltoluene and p-methylstyrene, halogenated styrenes, such as monochlorostyrenes, dichlorostyrenes, tribromostyrenes, and tetrabromostyrenes;
heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinyl-pyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinyl-pyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles, and hydrogenated vinylthiazoles, vinyloxazoles and hydrogenated vinyloxazoles;
vinyl and isoprenyl ethers;
maleic acid derivatives, such as maleic anhydride, methylmaleic anhydride, maleimide, methylmaleimide; and dienes, such as divinylbenzene.

The amount generally used of these comonomers is from 0 to 60% by weight, preferably from 0 to 40% by weight, and particularly preferably from 0 to 20% by weight, based on the weight of the monomers, and the compounds here may be used individually or as a mixture.

The polymerization is generally initiated by known free-radical initiators. Examples of preferred initiators are the azo initiators well known to persons skilled in the art, e.g. AIBN and 1,1-azobiscyclo-hexanecarbonitrile, and also peroxy compounds, such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethylhexane, tert-butylperoxy 2-ethylhexanoate, tert-butylperoxy 3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the abovementioned compounds with one another, and also mixtures of the abovementioned compounds with compounds not mentioned which can likewise form free radicals.

The amount often used of these compounds is from 0.01 to 3% by weight, preferably from 0.05 to 1% by weight, based on the weight of the monomers.

The abovementioned polymers may be used individually or as a mixture. Use may also be made here of various polycarbonates, poly(meth)acrylates or cycloolefinic polymers which differ, for example, in molecular weight or in monomer composition.

The plastics substrates of the invention may, for example, be produced from moulding compositions of the abovementioned polymers. For this, use is generally made of thermoplastic shaping processes, such as extrusion or injection moulding.

The weight-average molar mass M_{w} of the homo- and/or copolymers to be used according to the invention as moulding compositions for producing the plastics substrates may vary within a wide range, the molar mass usually being matched to the application and the method used for processing the moulding composition. However, with no intended resultant restriction, it is generally in the range from 20 000 to 1 000 000 g/mol, preferably from 50 000 to 500 000 g/mol, and particularly preferably from 80 000 to 300 000 g/mol. An example of a method for determining this variable is gel permeation chromatography.

The plastics substrates may also be produced by cell casting processes. In these, by way of example, suitable (meth)acrylic mixtures are charged to a mould and polymerized. These (meth)acrylic mixtures generally comprise the (meth)acrylates set out above, in particular methyl methacrylate. The (meth)acrylic mixtures may moreover comprise the copolymers set out above, and also, in particular for viscosity adjustment, may comprise polymers, in particular poly(meth)acrylates.

The weight-average molar mass M_{w} of the polymers prepared by cell casting processes is generally higher than the molar mass of polymers used in moulding compositions. This gives a number of known advantages. With no resultant intended restriction, the weight-average molar mass of polymers prepared by cell casting processes is generally from 500 000 to 10 000 000 g/mol.

Preferred plastics substrates prepared by the cell casting process may be obtained commercially with the trade name ®Plexiglas GS from Röhm GmbH & Co. KG.

The moulding compositions used to produce the plastics substrates, and also the acrylic resins, may also comprise conventional additives of any type. Examples of these are antistatic agents, antioxidants, mould-release agents, flame retardants, lubricants, dyes, flow improvers, fillers, light stabilizers and organophosphorus compounds, such as phosphoric esters, phosphoric diesters and phosphoric monoesters, phosphites, phosphorinanes, phospholanes or phosphonates, pigments, weathering stabilizers and plasticizers. However, the amount of additives is restricted in relation to the application.

Particularly preferred moulding compositions which encompass poly(meth)acrylates are obtainable with the trade name Acrylite® from the company Cyro Inc., USA. Preferred moulding compositions which encompass cycloolefinic polymers may be purchased with the trade name ®Topas from Ticona and ®Zeonex from Nippon Zeon. Polycarbonate moulding compositions are obtainable, by way of example, with the trade name ®Makrolon from Bayer or ®Lexan from General Electric.

The plastics substrate particularly preferably encompasses at least 80% by weight, in particular at least 90% by weight, based on the total weight of the substrate, of poly(meth)acrylates, polycarbonates and/or cycloolefinic polymers. The plastics substrates are particularly preferably composed of polymethyl methacrylate, and this polymethyl methacrylate may comprise conventional additives.

In one preferred embodiment, plastics substrates may have an impact strength to ISO 179/1 of at least 10 kJ/m², preferably at least 15 kJ/m².

The shape, and also the size, of the plastics substrate are not important for the present invention. Substrates generally used often have the shape of a sheet or a panel, and have a thickness in the range from 1 mm to 200 mm, in particular from 5 to 30 mm.

Before the plastics substrates are provided with a coating, they may be activated by suitable methods in order to improve adhesion. For this, by way of example, the plastics substrate may be treated by a chemical and/or physical process, the particular process here being dependent on the plastics substrate.

The plastics articles of the present invention are initially provided with an adhesion-promoting intermediate layer (b) located between the plastics substrate and the inorganic coating.

The important property of the adhesion-promoting layer is that its adhesion, both to the plastics surface and to the layer which inhibits water droplet formation, is greater than that of the latter to the plastics surface. While there are numerous organic polymer materials which adhere well to a water-repellent plastics surface, adequate adhesion to the layer which prevents water droplet formation requires particular properties.

These properties are based on polymers having polar groups and located in the adhesion-promoting layer, these polymers having low solubility and low swellability in water. The solubility of the polymers of the intermediate layer is generally lower than 1 g/l.

This polarity may generally be achieved via polar groups which may be a constituent of the main chain and/or of side chains.

The polymer may therefore be obtained by polyaddition or polycondensation reactions. Examples here are polyethers, polyesters, polycarbonates, polyurethanes, epoxy resins and polyamides.

Polyvinyl compounds are another group of compounds suitable as polymer. Examples of these are polyolefins, such as polypropylene, polyethylene; polyaryl compounds, such as polystyrene; poly(meth)acrylates and polyvinyl acetates. Vinyl compounds suitable for preparing these polymers have been set out above.

In order that these polymers have the adhesion-promoting action set out above, these polymers may encompass polar groups. These groups may be incorporated into the polymer, by way of example, via the selection of suitable copolymers. These groups may moreover also be grafted onto a polymer by graft copolymerization.

Particular polar groups which may be mentioned are hydroxy, carboxy, sulphonyl, carboxamide, nitrile and silanol groups. They are preferably a constituent of a macromolecular compound which also contains non-polar groups, such as alkyl, alkylene, aryl or arylene groups.

The ratio of polar to non-polar groups in the polymers has to be selected so as to achieve adhesion both to the water-repellent, i.e. non-polar, plastics surface, and also to the layer which inhibits water droplet formation, i.e. which is hydrophilic. The level of polarity must not be so high that the material of the adhesion-promoting layer itself is made water-soluble or water-swellable. The degree of swelling on saturation with water at 20° is not more than 10% by volume and preferably not more than 2% by volume. However, the level of polarity of the polymers is also intended not to be so low that the material would be soluble in completely non-polar solvents, such as naphtha. Most of the suitable materials are soluble in organic solvents of modest polarity, such as chlorinated hydrocarbons, esters, ketones, alcohols or ethers, or mixtures of these with aromatics.

The required balance of affinities with the two adjacent layers is generally achieved if the material of the adhesion-promoting layer contains from 0.4 to 100 milliequivalents of polar groups in 100 g of the polymer material.

Polar groups differ in their polarizing action. This increases in the sequence nitrile, hydroxy, prim. carboxamide, carboxy, sulphonyl, silanol. The stronger the polarizing action, the lower the content required in the polymer material. Whereas from 4 to 100 milliequivalents of polar groups in 100 g of polymer material are used in the case of the low-polarity groups, from 0.4 to 20 milliequivalents/100 g of the high-polarity groups is sufficient. If the selected content of polar groups is too low, the layer which inhibits water droplet formation does not have sufficient adhesion. In contrast, if the content of polar groups is too high, the water-swellability increases excessively, and this in turn reduces adhesion.

The polarity of the polymers obtained by polycondensation or polyaddition, and encompassing hydroxy groups, may be increased, inter alia, by reaction with silanes which, per silicon atom, have at least two hydrolyzable groups, such as halogen atom, alkoxy groups and/or aryloxy groups.

Examples of these compounds are tetraalkoxysilanes, such as tetramethoxysilane, tetraethoxysilane; trialkoxysilanes, such as methyltrimethoxysilane, methyltriethoxysilane, ethyltrimethoxysilane, n-propyl-trimethoxysilane, n-propyltriethoxysilane, isopropyl-triethoxysilane; dialkoxysilanes, such as dimethyldimethoxysilane, dimethyldiethoxysilane, diethyldimethyoxysilane, diethyldiethoxysilane, di-n-propyldimethoxysilane, di-n-propyldiethoxysilane, diisopropyldimethoxysilane, diisopropyldiethoxysilane.

The polymers which can be obtained by free-radical polymerization of vinyl compounds may also be modified, like the polymers which can be obtained by polycondensation or polyaddition.

To modify these polyvinyl compounds, use may in particular be made of silanes which encompass vinyl groups which are not hydrolyzable. Examples of the particularly suitable vinylic silane compounds are CH₂═CH—Si(OCH₃)₃, CH₂═CH—Si(OC₂H₅)₃, CH₃═CH—SiCl₃, CH₂═CH—Si(CH₃) (OCH₃)₂, CH₂═CH—CO₂—C₃H₇—Si(OCH₃)₃, CH₂═CH—CO₂—C₃H₇—Si(OCH₃)₃, CH₂═C(CH₃)—CO₂—C₃H₇—Si(OCH₃)₃, CH₂═C(CH₃)—CO₂—C₃H₇—Si(OC₂H₅)₃ and CH₂═C(CH₃)—CO₂—C₃H₇—SiCl₃.

Preference is also given to polymers which have groups which lead to crosslinking during and/or after the formation of the intermediate layer (b). Silanes having 3 hydrolyzable groups and also one vinylic group are particularly suitable for this purpose, and examples of these silanes have been set out above.

The polar polymers may be present either individually or as a mixture in the adhesion-promoting intermediate layer (b).

The intermediate layer (b) may moreover comprise conventional additives. Particular examples of these are flow control agents, which also encompass surfactants.

It is important that this intermediate layer is obtained via application from a solution which comprises a solvent with a volatility index smaller than or equal to 20, preferably smaller than or equal to 15. The volatility index (VI) is the ratio of the vaporization time measured for the liquid to be tested to the vaporization time for the comparative liquid diethyl ether (C₂H₅OC₂H₅), the test conditions being those described in DIN 53 170.

These compounds are well known and commercially available. It is preferable to use carboxylic esters, particular preference being given in particular to ethyl acetate, propyl acetate and butyl acetate.

In one particular aspect of the present invention, the intermediate layer (b) is applied from a solution which encompasses at least 70% by weight, preferably at least 90% by weight, of one or more solvents with a volatility index smaller than or equal to 20.

In one particular aspect of the present invention, softening of the substrate occurs on contact of the plastics substrate with the compounds with a volatility index smaller than or equal to 20. This plasticizing action of the compound with a volatility index smaller than or equal to 20 may be determined by way of an increase in the haze value in the Taber test (DIN 52347) after 10 revolutions. The test of DIN 52347 is carried out using an applied force of 5.4 N, and using “CS10F” abrasion wheels from the company Teledyne Taber. The haze value is determined as in Section 5.3.1. test method A. For this, the plastics substrate is immersed in an appropriate solvent for 60 minutes. Preferred compounds with a volatility index smaller than or equal to 20 exhibit a delta haze of at least 4%, preferably at least 6%, and particularly preferably 6.8%, in the subsequent Taber test after 10 revolutions of the abrasion wheel. PMMA is a particularly preferred substrate here.

However, in another preferred embodiment the plastics substrate does not become hazy on application of the intermediate layer. The compound with a volatility index smaller than or equal to 20 should then have a very high maximum period of action, this maximum period of action being the interval during which no haze of the plastics substrate occurs through contact of the compounds with a volatility index smaller than or equal to 20. The limit of this period of action may be determined through simple preliminary tests, the time expired before visible haze of the plastics substrate occurs being measured through the action of the compound with a volatility index smaller than or equal to 20. The haze occurring through contact compounds with a volatility index smaller than or equal to 20 may be determined by way of an increase in the haze value of 20%, methods for determining haze being set out in DIN 52347, in particular Section 5.3.1. test method A. This period of action is preferably at least 60 minutes, and preferably at least 240 minutes.

The coating mixtures set out above may be applied to the plastics substrates by any known method. Examples of these are immersion methods, spraying methods, doctoring, flow-coating methods, and application by rollers or by rolls. Among these, particular preference is given to flow coating.

Flow-coating processes are known to the person skilled in the art. A liquid is generally poured over the material. The pressure here is generally so low that the liquid does not produce any droplets as it comes into contact with the substrate. Excess coating composition is collected in a trough and, where appropriate, reapplied by way of filters. Nozzles are generally used for the application process, but the pressure selected is relatively low. Mechanical devices conduct these nozzles across the sheet or along the edge of the sheet, so that the liquid applied with very low pressure produces a flow curtain which uniformly coats the substrate. The amount of liquid, and also the advance rate at which the jet are conducted across the substrate, are selected to give uniform application of the coating. Further details in this connection are found in Brock/Groteklaes/Mischke “Lehrbuch der Lacktechnologie” [Textbook of coatings technology], 2nd edition, 1998, Vincentz Verlag.

The coating compositions used for the flow coating process generally comprise a solids content in the range from 0.01 to 5% by weight, preferably in the range from 0.1 to 3% by weight, in order to achieve a low coating thickness.

The coatings thus applied can generally be hardened or dried in a relatively short time, for example within from 1 minute to 1 hour, generally within from about 3 minutes to 30 minutes, preferably within from about 5 minutes to 20 minutes, and at comparatively low temperatures, for example at from 70 to 110° C., preferably at about 80° C.

The thickness of the intermediate layer is not particularly critical, but the total of the layer thicknesses of the inorganic coating (a) and of the intermediate layer (b) must be at most 700 nm. However, this is selected to be relatively low if possible, for reasons of cost-effectiveness, the lower limit being given by the stability of the entire coating (a) and (b). However, without any intended resultant restriction, the thickness of the adhesion-promoting intermediate layer after hardening is generally in the range from 50 nm to 400 nm, preferably from 100 nm to 200 nm. The layer thicknesses of the coatings (a) and/or (b) is determinable by way of a transmission electron micrograph (TEM), the average generally being determined by way of the integral for the area of the layer.

After the drying of the adhesion-promoting intermediate layer (b), an inorganic coating (a) which inhibits water droplet formation is applied thereto.

The expression “which inhibits water droplet formation” means that a water droplet forms a contact angle of at most 20°, preferably at most 10°, on the surface. This variable is determined at 20° C., using a G40 contact angle measurement system from the company Krüss, Hamburg.

For the purposes of the present invention, the term inorganic means that the carbon content of the inorganic coating is not more than 25% by weight, preferably not more than 17% by weight, and very particularly preferably not more than 10% by weight, based on the weight of the inorganic coating (a). This variable may be determined by elemental analysis.

Particular inorganic coatings which may be applied are polysiloxanes, silane cocondensates and silica sols, the carbon content of these being restricted to the ranges set out above.

Silane cocondensates which may serve for production of the coating (a) are known per se and are used as additives to polymeric glazing materials. Their inorganic character gives them good resistance to UV radiation and weathering effects.

These silane cocondensates may be obtained, inter alia, via condensation or hydrolysis of organosilicon compounds of the general formula (I)
R¹ₙSiX₄₋ₙ (I)
where R¹ is a group having from 1 to 20 carbon atoms, X is an alkoxy radical having from 1 to 20 carbon atoms, or a halogen, and n is an integer from 0 to 3, preferably 0 or 1, and where the various radicals X or R¹ may in each case be identical or different.

The expression “a group having from 1 to 20 carbon atoms” characterizes radicals of organic compounds having from 1 to 20 carbon atoms. It encompasses alkyl groups, cycloalkyl groups, aromatic groups, alkenyl groups and alkynyl groups having from 1 to 20 carbon atoms, and also heteroaliphatic and heteroaromatic groups which have in particular oxygen atoms, nitrogen atoms, sulphur atoms and phosphorus atoms, besides carbon atoms and hydrogen atoms. These groups mentioned may be branched or unbranched, and the radical R¹ here may be substituted or unsubstituted. Among the substituents are in particular halogens, groups having from 1 to 20 carbon atoms, nitro groups, sulphonic acid groups, alkoxy groups, cycloalkoxy groups, alkanoyl groups, alkoxycarbonyl groups, sulphonic ester groups, sulphinic acid groups, sulphinic ester groups, thiol groups, cyanide groups, epoxy groups, (meth)acryloyl groups, amino groups and hydroxy groups. For the purposes of the present invention, the term “halogen” means a fluorine atom, chlorine atom, bromine atom or iodine atom.

Among the preferred alkyl groups are the methyl, ethyl, propyl, isopropyl, 1-butyl, 2-butyl, 2-methylpropyl, tert-butyl, pentyl group, and the 2-methylbutyl group.

Examples of preferred cycloalkyl groups are the cyclopropyl, cyclobutyl, cyclopentyl, cyclohexyl and cycloheptyl group, and the cyclooctyl group, these having substitution, where appropriate, by branched or unbranched alkyl groups.

Examples of preferred alkoxy groups are the methoxy, ethoxy, propoxy, butoxy, tert-butoxy, hexyloxy, 2-methylhexyloxy and decyloxy group, or dodecyloxy group.

Examples of preferred cycloalkoxy groups are cycloalkoxy groups whose hydrocarbon radical is one of the abovementioned preferred cycloalkyl groups.

The radical R¹ is particularly preferably a methyl or ethyl group.

With respect to the definition of the group X in formula (I) in relation to the alkoxy group having from 1 to 20 carbon atoms, and the halogen, reference may be made to the abovementioned definition. The group X is preferably a methoxy or ethoxy radical or a bromine or chlorine atom.

These compounds may be used individually or as a mixture to prepare silane cocondensates.

Based on the weight of the condensable silane compounds, it is preferable for at least 80% by weight, in particular at least 90% by weight, of the silane compounds used to have four alkoxy groups or halogen atoms.

Tetraalkoxysilanes encompass tetramethoxysilane, tetraethoxysilane, tetra-n-propoxysilane, tetraisopropoxysilane and tetra-n-butoxysilanes.

Particular preference is given to tetramethoxysilane and tetraethoxysilane. In one particular aspect of the present invention, the proportion of these particularly preferred tetraalkoxysilanes is at least 80% by weight, in particular at least 90% by weight, based on the weight of the silane compounds used.

In another aspect of the present invention, use may also be made of silane condensates which comprise colloidally dispersed SiO₂ particles. These dispersions may be obtained by the sol-gel process, in particular condensing tetraalkoxysilanes and/or tetrahalosilanes. Aqueous coating compositions are usually prepared from the abovementioned silane compounds by hydrolyzing organosilicon compounds with an amount of water sufficient for the hydrolysis process, i.e. >0.5 mol of water per mole of the groups intended for hydrolysis, e.g. alkoxy groups, preferably with acid catalysis. Examples of acids which may be added are inorganic acids, such as hydrochloric acid, sulphuric acid, phosphoric acid, nitric acid, etc., or organic acids, such as carboxylic acids, organic sulphonic acids, etc., or acidic ion exchangers, the pH during the hydrolysis reaction generally being from 2 to 4.5, preferably 3.

Once the reactants have been combined, a rise in temperature is generally observed. In certain instances it can be necessary to introduce external heat in order to start the reaction, for example by heating the mixture to 40-50° C. Care is generally taken to prevent the reaction temperature from exceeding 55° C. The reaction time is generally relatively short, and is usually less than one hour, for example 45 min.

The silane compounds may be condensed to give polymers whose weight-average molar mass M_{w} is generally in the range from 100 to 20 000 g/mol, preferably from 200 to 10 000 g/mol, and particularly preferably from 500 to 1500 g/mol. An example of a method for determining this molar mass is NMR spectroscopy.

Examples of ways of terminating the condensation reaction are cooling to temperatures below 0° C., or increasing the pH, using suitable bases, such as organic bases, e.g. amines, alkali metal hydroxides or alkaline earth metal hydroxides.

For further operations, some of the water/alcohol mixture and of the volatile acids may be removed from the reaction mixture, for example by distillation.

The silane cocondensates which can be used according to the invention may comprise curing catalysts, for example in the form of zinc compounds and/or of other metal compounds, e.g. cobalt compounds, copper compounds or calcium compounds, and in particular their octoates or naphthenates. Without any intended resultant restriction, the content of the curing catalysts is generally from 0.1 to 2.5% by weight, specifically from 0.2 to 2% by weight, based on the entire silane cocondensate. By way of example, mention may be made in particular of zinc naphthenate, zinc octoate, zinc acetate, zinc sulphate, etc.

Use may also be made of oxide layers, in particular semimetal and metal oxides, as coating (a) which inhibits water droplet formation. Among suitable compounds are in particular oxides and hydroxides which derive from silicon, from aluminium, from titanium, from zirconium, from zinc and/or from chromium.

These oxides may be used individually or as mixtures, for example in the form of mixed oxides. These oxides and/or hydroxides should have minimum solubility in water, and the solubility in water at 20° should, for example, be below 1000 μg/l, preferably below 200 μg/l.

These oxides may, for example, be applied in the form of colloidal solutions obtained by hydrolysis of alkoxy compounds. These colloidal solutions are disclosed by way of example in EP-A-0 149 182, EP-A-0 826 663, EP-A-0 850 203 and EP-1 022 318.

The particle size of these oxide particles is not critical, but transparency is dependent on the particle size. The size of the particles is preferably at most 300 nm, in particular in a range from 1 to 200 nm, preferably from 1 to 50 nm.

In one particular aspect of the present invention, the colloidal solution is preferably applied at a pH greater than or equal to 7.5, in particular greater than or equal to 8, and particularly preferably greater than or equal to 9.

Basic colloidal solutions are less expensive than acidic solutions. In addition, basic colloidal solutions of oxide particles are particularly easy to store and can be stored for a long time.

The coating compositions described above may be obtained commercially with the trade name ®Ludox (from the company Grace, Worms); ®Levasil (from the company Bayer, Leverkusen); ®Klebosol (from the company Clariant).

The coating compositions for producing the inorganic coating (a) may moreover comprise conventional additives and processing aids. Examples of these are in particular flow control agents, which also encompass surfactants.

The coating compositions set out above for producing the inorganic coating (a) may be applied by any known method to the plastics substrates, these having been set out above by way of example.

Preference is particularly given to flow coating processes, but here the selection of additives are limited to substances which have substantially no adverse effect on the action of inhibiting water droplet formation.

Preference is given to the use of anionic flow control agents, these having high miscibility with water. In particular, the amount soluble in 1000 g of water at 20° C. without appearance of another phase, in particular without formation of micelles is in particular at least 10 g, preferably at least 50 g, and particularly preferably at least 150 g.

For the purposes of the present invention, flow control agents are compounds which reduce the surface energy of water. In one particular aspect of the present invention, an aqueous mixture which encompasses 0.1% by weight of flow control agents has a surface tension at 20° C. which is below the surface tension of pure water by at least 5 mN/m, preferably by at least 10 mN/m, and particularly preferably by at least 15 mN/m. The surface tension may be determined as described by Lecompte du Noüy to DIN 53914, using the Krüss K8600 E/E interfacial tensiometer.

Anionic flow control agents are known to persons skilled in the art, and these flow control agents generally have carboxy groups, sulphonate groups and/or sulphate groups. These flow control agents preferably encompass at least one sulphonate group. A distinction has to be made between these and amphoteric flow control agents which encompass not only an anionic group but also a cationic group.

The anionic flow control agents preferably encompass from 2 to 20, particularly preferably from 2 to 10, carbon atoms, and the organic radical here may contain aliphatic or aromatic groups. In one particular aspect of the present invention, use is made of anionic flow control agents which encompass an alkyl or cycloalkyl radical having from 2 to 10 carbon atoms.

The anionic flow control agents may have other polar groups, such as carboxy, thiocarboxy or imino, carboxylic ester, carbonic ester, thiocarboxylic ester, dithiocarboxylic ester, thiocarbonic ester, dithiocarbonic ester and/or dithiocarbonic amide groups.

Particular preference is given to the use of flow control agents of the formula (II) 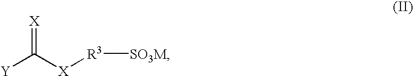
where X, independently, is an oxygen or a sulphur atom, Y is a group of the formula OR², SR² or NR², where R², independently, is an alkyl group having from 1 to 5, preferably from 1 to 3, carbon atoms, and R³ is an alkylene group having from 1 to 10, preferably from 2 to 4, carbon atoms, and M is a cation, in particular an alkali metal ion, in particular potassium or sodium, or an ammonium ion.

The amount of anionic flow control agent added is limited to that which has substantially no adverse effect on the coating which inhibits water droplet formation. The amount generally added to the coating composition is from 0.01 to 1% by weight, in particular from 0.03 to 0.1% by weight, of one or more anionic flow control agents, based on the total weight of the coating compositions.

These compounds may in particular be obtained from Raschig with the trade name Raschig OPX or Raschig DPS.

Besides the anionic flow control agent, the coating composition may encompass other flow control agents, in particular non-ionic flow control agents. Of these, particular preference is given to ethoxylates, and use may be made here in particular of esters, and also of alcohols and phenols having ethoxy groups. Examples of these are nonylphenol ethoxylate.

The ethoxylates encompass in particular from 1 to 20, in particular from 2 to 8, ethoxy groups. The hydrophobic radical of the ethoxylated alcohols and esters preferably encompasses from 1 to 40, preferably from 4 to 22, carbon atoms, and use may be made here of linear or branched alcohol and/or ester radicals.

These products may be obtained commercially, for example with the trade name ®Genapol X80.

The amount of non-ionic flow control agent added is restricted to that which has substantially no adverse effect on the coating which inhibits water droplet formation. The amount generally added to the coating composition is from 0.01 to 2% by weight, in particular from 0.1 to 1% by weight, of one or more non-ionic flow control agents, based on the total weight of the coating composition.

If both an anionic and a non-ionic flow control agent are added to the coating composition to produce the inorganic coating, the ratio by weight of anionic flow control agent to non-ionic flow control agent is preferably in the range from 0.01:1 to 1:1, particularly preferably from 0.05:1 to 0.3:1.

The surface finishes thus applied can generally be fully hardened to give coatings with excellent adhesion in a relatively short time, for example within from 0.5 minute to 1 hour, generally within from about 1 minute to 30 minutes, preferably within from 3 minutes to 20 minutes, and at a comparatively low temperature, for example from 60 to 110° C., preferably at about 80° C.

The layer thickness of the inorganic coating (a) is relatively non-critical, but the total of the layer thicknesses and of the inorganic coating (a) and of the intermediate layer (b) must be at most 700 nm. However, without any intended resultant restriction, the value of this variable after the hardening process is generally in the range from 50 nm to 600 nm, preferably from 100 nm to 400 nm, and particularly preferably from 150 nm to 250 nm.

The total of the total of the layer thicknesses of the inorganic coating (a) and of the intermediate layer (b) must be at most 700 nm, and this value is preferably in the range from 100 to 500 nm.

The plastics articles of the present invention give excellent results in the thermoforming process, with no resultant damage to their coating which inhibits water droplet formation. The forming process is known to the person skilled in the art. In this process, the plastics article is heated and formed by way of a suitable template. The temperature at which the forming process takes place depends on the softening point of the substrate from which the plastics article was produced. The other parameters, for example the forming rate and forming force, are likewise dependent on the plastic, these parameters being known to the person skilled in the art. Among the forming processes, particular preference is given to bending processes. These processes are in particular used for the processing of cast transparent sheets. Further details are found in “Acrylglas und Polycarbonat richtig Be-und Verarbeiten” [Correct machining and use of acrylic sheet and polycarbonate] by H. Kaufmann et al. edited by Technologie-Transfer-Ring Handwerk NRW and in VDI-Richtlinie [VDI guidelines] 2008 Sheet 1, and also DIN 8580/9/.

The plastics articles of the present invention, provided with a coating which inhibits water droplet formation, have high scrub resistance. The scrub resistance to DIN 53778 is preferably greater than or equal to 3000 cycles, in particular greater than or equal to 5000 cycles, and particularly preferably greater than or equal to 10 000 cycles.

In one particular aspect of the present invention, the plastics article is transparent, the transparency τ_{D65/10} to DIN 5033 being at least 70%, preferably at least 75%.

Without any intended resultant restriction, the plastics article preferably has a modulus of elasticity to ISO 527-2 of at least 1000 MPa, in particular at least 1500 MPa.

The plastics articles of the invention are generally highly resistant to weathering. For example, the weathering resistance to DIN 53387 (Xenotest) is at least 5000 hours.

Without any intended resultant restriction, the yellowness index to DIN 6167 (D65/10) of preferred plastics articles remains smaller than or equal to 8, preferably smaller than or equal to 5, even after prolonged UV irradiation for more than 5000 hours.

The plastics articles of the present invention may be used in the construction sector, for example, in particular for the production of greenhouses or conservatories, or may serve as a noise barrier.

The invention is illustrated in more detail below by way of inventive examples and comparative examples, but there is no intention that the invention be restricted to these inventive examples.

### INVENTIVE EXAMPLE 1

Production of the Adhesion-Promoting Intermediate Layer

A copolymer composed of 87.6% of methyl methacrylate and 12.4% of gamma-methacryloyloxypropyltrimethoxy-silane dissolved in butyl acetate, the solids content being 0.7% by weight, and applied by flow coating in a thin layer to PMMA sheets across a length of 3 m. The volatility index of butyl acetate is 11. After run-off, the coated sheet is dried in an oven at 80° C. for 20 min.

Production of the Layer which Inhibits Water Droplet Formation

25 parts by weight of an anionic silica sol (solids content 30%; ®Levasil obtainable from Bayer AG), with 0.1 part by weight of the potassium salt of the 3-sulphopropyl ester of O-ethyldithiocarbonic acid (®Raschig OPX obtainable from Raschig AG) and 0.4 part by weight of an ethoxylated fatty alcohol ®Genapol X80) are made up to 100 parts by weight with deionized water, adjusted to pH 9.5 using NaOH, and coated by flow coating in a thin layer onto the sheet provided with the adhesion-promoting layer. The flow coating path length was 3 m (sheet length), and the advance rate of the flow coating nozzle was 0.75 m/min.

After air-drying, the sheet provided with adhesion-promoting layer and with layer which inhibits water droplet formation is dried in a convection oven at 80° C. for 20 min.

A transmission electron microscope may be used to determine the thickness of the extremely thin layers, by way of a thin section. The thickness of the intermediate layer was in the range from 140 to 220 nm, depending on the direction of flow coating, and that of the inorganic coating was from 170 to 270 nm.

The adhesion of the coating was determined by the wet scrub test to DIN 53778, using an M 105/A wet scrub tester from the company Gardner. A value of 10 000 cycles was determined at a total layer thickness of 310 nm (upper region of the coated sheet, viewed in the direction of flow coating). The value determined at a total layer thickness of 490 nm was 17 000 cycles (lower region of the sheet).

The plastics article was also thermoformed. The method of thermoforming consisted in heating the coated sheets to 150-170° C. in a convection oven. The selection of the temperature depends on the heat resistance of the substrate. In the case of extruded PMMA, which unlike cast PMMA contains plasticizing comonomers, e.g. acrylates, and has a comparatively low molecular weight, even a relatively low temperature is sufficient. In the case of cast PMMA, which has molecular weights above 1 million, extending to two or more million, and is often composed of pure MMA homopolymer, where appropriate with slight crosslinking, the temperature used is relatively high. Once the sheets have softened, they are bent over a semicircular mould with a prescribed bending radius, and allowed to cool, further details of bending being given in “Acrylglas und Polycarbonat richtig Be-und Verarbeiten” [Correct machining and use of acrylic sheet and polycarbonate] by H. Kaufmann et al. edited by Technologie-Transfer-Ring Handwerk NRW. After forming with a bending radius of 47.5 mm, the sheets produced in Example 1 have no haze or cracks in the coating, and are effective in inhibiting water droplet formation, with low contact angles.

The assessment of inhibition of water droplet formation can only take place visually on the curved substrate, because curved specimens are not within the measuring capabilities of the goniometer. In this case, they were qualitatively assessed as good.

Again no wet scrub test can be carried out on the curved specimens, because this test also requires flat substrates.

### COMPARATIVE EXAMPLE 1

Inventive Example 1 was substantially repeated, but the adhesion-promoting intermediate layer was applied by flow coating from a mixture of the copolymer with MOP (1-methoxy-2-propanol). The volatility index of MOP is 22.

The layer thicknesses of the coatings were identical with those of Inventive Example 1. Formation of water droplets was likewise effectively inhibited.

The scrub resistance was likewise from 10 000 to 17 000 cycles, depending on the flow path length of the solution during flow coating. On thermoforming, severe haze was observed, whereupon the visual assessment of inhibition of water droplet formation was poor.

1. A formable plastic article which inhibits water droplet formation comprising a plastic substrate, at least one inorganic coating (a) which inhibits water droplet formation, and one adhesion-promoting intermediate layer (b) located between the plastics substrate and the inorganic coating, obtained by applying the intermediate layer (b) from a mixture with a solvent which has a volatility index smaller than or equal to 20, the total of the layer thicknesses of the inorganic coating (a) and of the intermediate layer (b) being at most 700 nm and one of more nonionic flow control agents and an anionic flow control agent are added to coating composition (a), the ratio by weight of anionic flow control agent to nonionic flow control agent being in the range from 0.01:1 to 1:1.

2. The formable plastic article according to claim 1, wherein the solvent has a volatility index smaller than or equal to 15.

3. The formable plastic article according to claim 1, wherein the mixture from which the intermediate layer is applied encompasses at least 70% by weight of a solvent which has a volatility index smaller than or equal to 20.

4. The formable plastic article according to claim 1, wherein the compound having a volatility index smaller than or equal to 20 gives a delta haze of at least 6% after 60 minutes of exposure time and 10 abrasion wheel rotations.

5. The formable plastic article according to claim 1, wherein the solvent is a carboxylic ester.

6. The formable plastic article according to claim 1, wherein the plastics substrate encompasses cycloolefin copolymers, polyethylene terephthalates, polycarbonates, and/or poly(meth)acrylates.

7. The formable plastic article according to claim 1, wherein the plastics substrate is composed of polymethyl methacrylate.

8. The formable plastic article according to claim 1, wherein the plastics substrate has an impact strength of at least 10 kJ/m² to ISO 179/1.

9. The formable plastic article according to claim 1, wherein the plastics substrate has a thickness in the range from 1 mm to 200 mm.

10. The formable plastic article according to claim 1, wherein the thickness of the adhesion-promoting intermediate layer (b) is in the range of 50 and 400 nm.

11. The formable plastic article according to claim 1, wherein the adhesion-promoting intermediate layer encompasses vinyl polymers modified by polar groups.

12. The formable plastic article according to claim 1, wherein the carbon content of the inorganic coating (a) is at most 17% by weight, based on the weight of the coating (a).

13. The formable plastic article according to claim 1, wherein the inorganic coating (a) is obtainable by curing colloidal solutions of inorganic and/or organometallic compounds.

14. The formable plastic article according to claim 1, wherein the inorganic coating (a) is obtainable by condensing a composition which encompasses at least 80% by weight of alkyltrialkoxysilanes and/or tetra-alkoxysilanes, based on the content of condensable silanes.

15. The formable plastic article according to claim 1, wherein the layer thickness of the coatings (a) and (b) is in the range from 100 to 500 nm.

16. The formable plastic article according to claim 1, wherein the scrub resistance of the plastics article to DIN 53778 is at least 10 000 cycles.

17. The formable plastic article according to claim 1, wherein the plastics article has a modulus of elasticity to ISO 527-2 of at least 1500 MPa.

18. The formable plastic article according to claim 1, wherein the plastics article has a weathering resistance to DIN 53 387 of at least 5000 hours.

19. The formable plastic article according to claim 1, wherein the plastics article has a transparency to DIN 5033 of at least 70%.

20. A process for producing plastics articles which inhibit water droplet formation, according to claim 1, wherein
a) an adhesion-promoting coating (b) is applied to a plastics substrate from a mixture with a compound which has a volatility index smaller than or equal to 20, and is cured, and then
b) an inorganic coating (a) which inhibits formation of water droplets is applied and cured.

21. The process according to claim 20, wherein the coating (b) is applied by flow coating.

22. The process according to claim 20, wherein the coating (a) is applied by flow coating.
